(19) United States
(12) Patent Application Publication
(10) Pub. No.: US 2013/0122208 A1
(43) Pub. Date: May 16, 2013

(54) Coating Material and Method for Waterproofing a Surface

(71) Applicant: Blue Angel Paint and Coatings, Ltd., Homer Glen, IL (US)

(72) Inventors: John Bilotto, Crown Point, IN (US); Richard J. Pulciani, SR., Homer Glen, IL (US); Richard J. Pulciani, JR., Joliet, IL (US); R. Kerry Lane, Pryor, OK (US)

(73) Assignee: Blue Angel Paint and Coatings, Ltd., Homer Glen, IL (US)

(21) Appl. No.: 13/739,073

(22) Filed: Jan. 11, 2013

Related U.S. Application Data
(63) Continuation-in-part of application No. 13/246,468, filed on Sep. 27, 2011.
(60) Provisional application No. 61/442,425, filed on Feb. 14, 2011.

(51) Int. Cl. C09D 5/00

(52) U.S. Cl. CPC C09D 5/00
USPC 427/407.1; 524/437; 523/122; 524/388; 524/417

(57) ABSTRACT

Waterproofing material, including a base coat and a top coat, and a method for waterproofing a surface are described. The base coat includes about 60-70 percent rubber emulsion which further comprises a first rubber emulsion and a second rubber emulsion, about 3-10 percent fire retardant, about 3-10 percent opacity filler, and about 10-64 percent of other components. The top coat includes about 40-80 percent of a rubber emulsion, about 10-20 percent of a carbonate filler, about 3-10 percent of a fire retardant, about 3-10 percent of an opacity filler, and about 0-44 percent of other components. The method includes applying a base coat to a desired thickness allowing the base coat to dry, then applying a top coat over the base coat to a desired thickness.

### RELATED APPLICATIONS

The subject application is a continuation-in-part of U.S. Utility application Ser. No. 13/246,468, filed Sep. 27, 2011, and claims priority to U.S. Provisional Application No. 61/442,425, filed on Feb. 14, 2011 and incorporates each of these documents by reference.

### TECHNICAL FIELD

The present invention relates to a method for waterproofing a surface, such as a wall, floor or ceiling, as well as a durable waterproof coating material.

### BACKGROUND

Waterproofing surfaces, such as basement walls or a garage floor, is a key step in protecting one's home and personal possessions from water damage and moisture accumulation which can lead to mold growth. Among the ways to accomplish this task include the application of a waterproof paint to the walls and floors. In addition, application of a waterproof paint to walls and floors may improve the appearance of these surfaces.

Several types of waterproof paint exist on the market with varying degrees of durability and price. These include masonry paint, epoxy paint, and acrolein elasticized paint. Special care, including handling and application precautions, may be required with some of these paints as they contain potentially hazardous materials.

Masonry paint is designed to adhere to generally porous surfaces, such as brick, concrete and other hard surfaces. It is generally oil, water or latex-based, having a formulation that permits moisture to escape from the crevices of porous surfaces, while preventing moisture from getting into the surface. Masonry paints are usually mildew resistant and are relatively easily to clean.

Epoxy paint is probably most commonly used for basement and garage flooring because of the paint's durability and water-resistant capabilities. Epoxy paint contains a plastic resin that hardens rapidly as it dries, forming a durable waterproof seal that will adhere to stone, metal, concrete, cement as well as other surfaces. Epoxy paints are generally expensive.

Acrolein elasticized paint is a waterproof paint used primarily on concrete surfaces. Like masonry paint, this paint may inhibit the growth of mold, mildew and other bacteria associated with the presence of moisture. The chemicals in arcolein elasticized paints, however, may be hazardous or toxic with used alone or in large amounts, so these paints are typically mixed with acrylic paints to create a waterproof combination.

The present waterproofing material provides a barrier against water, mold and mildew for a variety of surfaces, including cinder block, concrete and stone, while avoiding the issues discussed with regard to the previous waterproof paints. These and other problems are addressed by the present invention without sacrificing effectiveness, safety, cost and other important waterproofing concerns.

### SUMMARY OF THE INVENTION

A waterproof coating material, including an individual base coat and a separate top coat, and a method for waterproofing a surface by applying such material, is disclosed.

In an embodiment, the base coat material includes about 60 to about 70 percent by weight of a rubber emulsion, which may include about 20 to about 50 percent by weight of a first rubber emulsion and about 20 to about 40 percent by weight of a second rubber emulsion, about 10 to about 30 percent by weight of a fire retardant, about 3 to about 12 percent by weight of an opacity filler, and about 10 to about 64 percent by weight of other components for affecting characteristics of the base coat material.

In an embodiment, the top coat material includes about 55 to about 75 percent by weight of a rubber emulsion, about 12 to about 30 percent by weight of a fire retardant, about 3 to about 12 percent by weight of an opacity filler, and about 5 to about 10 percent by weight of other components for affecting characteristics of the top coat material.

An embodiment of the application process includes the steps of applying a base coat material to a surface, allowing the base coat to dry, then applying a top or finish coat material over the base coat. When properly applied, one gallon of the waterproof material will cover a surface area (single coat) in the range of from about 150 to about 175 square feet at about 8 milliliters thickness.

These and other embodiments of the material, individual coatings, and the application method are described in detail in the following specification with reference to the appended drawing figure.

### BRIEF DESCRIPTION OF THE DRAWINGS

For the purpose of facilitating an understanding of the subject matter sought to be protected, there are illustrated in the accompanying drawing figures, embodiments thereof, from an inspection of which, when considered in connection with the following description, the subject matter sought to be protected, its construction and operation, and many of its advantages should be readily understood and appreciated.

FIG. 1 is cross section of a substrate coated with an embodiment of the waterproofing material of the present invention.

### DETAILED DESCRIPTION A PREFERRED EMBODIMENT

While this invention is susceptible of embodiments in many different forms, there is shown in the drawings, and will herein be described in detail, at least one preferred embodiment of the invention with the understanding that the present disclosure is to be considered as an exemplification of the principles of the invention and is not intended to limit the broad aspect of the invention to embodiments illustrated.

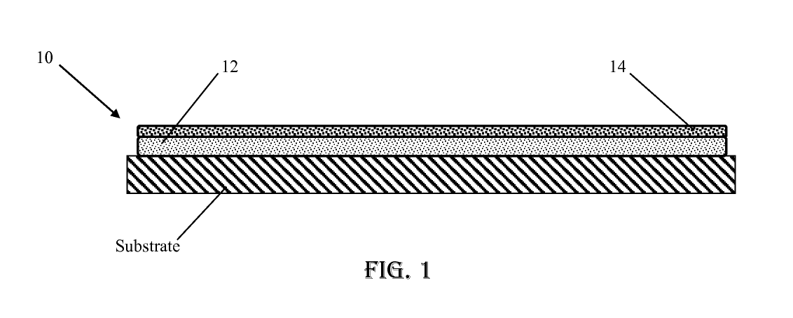

As illustrated in FIG. 1, the waterproofing composition 10 of the present invention is preferably comprised of two distinct coating materials, a base coat material 12 and a top coat material 14. With proper application, the disclosed composition has the ability of sealing a surface, such as a wall, ceiling, floor, etc., to provide needed waterproofing. By “waterproofing” it is meant that a properly treated surface or substrate will be impervious to any type of moisture penetration in accordance with Section 15 of ASTM D2939.

In fact, based on independent laboratory testing, International Building Code (IBC) and the International Code Council found an embodiment of the claimed composition met or exceeded each of the following material standards:

AC115; ANSI 118.10; ANSI 12

ASTM C1306 (Hydrostatic Pressure Over Cracks);

ASTM D2939 Section 15 (Resistance to Water);

ASTM D522 (Low Temperature Flexibility, 90/180 degree bend at −26° C.);

ASTM C836 Section 6.12 (Adhesion);

ASTM E154 (Resistance to Decay);

ASTM E96 (Water Vapor Permeance);

ASTM D2240 (Shore A durometer Hardness);

ASTM C836 Section 6.12 (Extensibility After Heat Aging);

ASTM 2574-94 (Mold);

ASTM D3273 and D3274 (Mold);

ASTM D2370 (Tensile and Elongation, 500% Elongation);

ASTM C836 Section 6.19 (Remain in Place During Application);

ASTM E84-11; and

UL Class A fire rated in accordance with ANSI UL 723 (Surface Burning Characteristics for Building Materials).

Further, the product is also “Green Guard” certified, which means the waterproof material 10 has met some of the world's most rigorous and comprehensive standards for low emissions of volatile organic compounds (VOCs). Information on the standards can be found at the Greenguard Environmental Institute website (http://www.greenguard.org/en/technicalCenter/tech_standards.aspx), which is hereby incorporated by reference.

Preferred compositions for the two separate coating layers are set forth in TABLE 1 (Base Coat 12) and TABLE 2 (Top Coat 14) below:

TABLE 1
Base Coat Formula-Preferred Composition

| | Weight Percentage | Wt % | Commercial |
|---|---|---|---|
| Material | (wt %) | Range | Product |
| Styrenated Butadiene | 39.170 | 20-50 | CP-501 Emulsion |
| Rubber Emulsion | | | |
| Defoamer | 0.500 | 0-2 | FGK Defoamer |
| Freeze/Thaw Additive | 0.500 | 0-2 | Propylene Glycol |
| Surfactant | 0.250 | 0-1 | Triton X-100 |
| Biocide | 0.200 | 0-1 | Nuocept 498 |
| Dispersant | 0.100 | 0-1 | Potassium Tripolyphosphate |
| Dispersant | 0.150 | 0-1 | Tamol 851 |
| Fire Retardant | 21.000 | 10-30 | Aluminum Trihydrate |
| Opacity Filler | 6.500 | 3-12 | TioPrem Gray TiO₂ |
| Fungicide | 0.200 | 0-1 | Fungitrol 404D |
| Styrene Butadiene Acrylic | 30.000 | 20-40 | SP-405 Emulsion |
| copolymer Emulsion | | | |
| Pigment Dispersion | 0.063 | 0-1 | 8592 Carbon Black |
| Diluent | 0.503 | 0-1 | Water |
| Acrylic Emulsion Thickener | 0.664 | 0-2 | CP-590 Emulsion |
| pH Neutralization | 0.200 | 0-1 | AMP-95 |
| TOTAL | 100.000 | | |

TABLE 2
Top Coat Formula-Preferred Composition

| | Weight Percentage | Wt % | Commercial |
|---|---|---|---|
| Material | (wt %) | Range | Product |
| Styrenated Butadiene | 67.400 | 55-75 | CP-501 Emulsion |
| Rubber Emulsion | | | |
| Defoamer | 0.500 | 0-2 | FGK Defoamer |
| Freeze/Thaw Additive | 0.500 | 0-2 | Propylene Glycol |
| Surfactant | 0.250 | 0-1 | Triton X-100 |
| Biocide | 0.200 | 0-1 | Nuocept 498 |
| Dispersant | 0.100 | 0-1 | Potassium Tripolyphosphate |
| Dispersant | 0.150 | 0-1 | Tamol 851 |
| Fire Retardant | 21.000 | 12-30 | Aluminum Trihydrate |
| Opacity Filler | 6.500 | 3-12 | 2300 Titanium Dioxide |
| Fungicide | 0.200 | 0-1 | Fungitrol 404D |
| Diluent | 2.340 | 1-4 | Water |
| Acrylic Emulsion Thickener | 0.590 | 0-2 | CP-590 Thickener |
| pH Neutralization | 0.270 | 0-1 | AMP-95 |
| TOTAL | 100.000 | | |

Each of the two formulas is preferably comprised of solids in the range of from about 55% to about 70%, most preferably about 62% solids. The composition is to be mixed together thoroughly with all ingredients, as would be understood by those skilled in the art. While a broader range of the weight percentage of each ingredient is possible to produce a suitable waterproofing material, the uniquely preferred composition set forth in TABLE 1 is believed to provide the greatest waterproofing benefits when properly applied to a surface.

For example, a base coat may have the following weight percentage variations while still producing suitable, though not necessarily optimal, waterproofing characteristics: about 60 to about 70 percent by weight of a rubber emulsion; about 10 to about 30 percent by weight of a fire retardant; about 3 to about 12 percent by weight of a opacity filler; and about 10 to about 64 percent by weight of other components for affecting characteristics of the base coat material.

Likewise, the top coat may have the following weight percentage variations while still producing suitable, though not necessarily optimal, waterproofing characteristics: about 55 to about 75 percent by weight of a rubber emulsion; about 12 to about 30 percent by weight of a fire retardant; about 3 to about 12 percent by weight of a opacity filler; and about 0 to about 44 percent by weight of other components for affecting characteristics of the top coat material.

The “other components” for the base coat include defoamer, freeze/thaw additive, surfactant, biocide, dispersant, fungicide, pigment dispersion, diluent, thickener, and a pH adjuster. For the top coat the “other components” are selected from the group consisting of defoamer, freeze/thaw additive, surfactant, biocide, dispersant, fungicide, diluent, thickener, and a pH adjuster.

For best results, the base coat is applied to a clean dry surface to a preferred thickness in the range of from about 25 to about 30 mil., and the top or finish coat is applied to a thickness in the range of from about 7 to about 10 mil. The thickness of the coatings should be measured and tested when wet, as shrinkage does occur during drying.

The coatings are preferably applied by a commercial airless sprayer having a 3.17 to 3.19 mm spray tip to achieve a quality coverage of the surface, as such coverage may directly affect the waterproofing quality of the material. However, where such a sprayer is impractical or unusable, each coating may be applied using a roller or brush. The user should be diligent in applying each coating across the complete surface and to the desired thickness.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A waterproof coating material comprising:
a base coat material having the following formula:
about 60 to about 70 percent by weight of a rubber emulsion;
about 10 to about 30 percent by weight of a fire retardant;
about 3 to about 12 percent by weight of an opacity filler; and
about 10 to about 64 percent by weight of other components for affecting characteristics of the base coat material; and
a top coat material having the following formula:
about 55 to about 75 percent by weight of a rubber emulsion;
about 12 to about 30 percent by weight of a fire retardant;
about 3 to about 12 percent by weight of a opacity filler; and
about 0 to about 44 percent by weight of other components for affecting characteristics of the top coat material.

2. The waterproof coating material of claim 1, wherein the other components for affecting characteristics of the base coat material are selected from the group consisting of defoamer, freeze/thaw additive, surfactant, biocide, dispersant, fungicide, pigment dispersion, diluent, thickener, and a pH adjuster.

3. The waterproof coating material of claim 1, wherein the other components for affecting characteristics of the top coat material are selected from the group consisting of defoamer, freeze/thaw additive, surfactant, biocide, dispersant, fungicide, diluent, thickener, and a pH adjuster.

4. The waterproof coating material of claim 1, wherein the rubber emulsion further comprises about 20 to about 50 percent by weight of a first rubber emulsion and about about 20 to about 40 percent by weight of a second rubber emulsion.

5. The waterproof coating material of claim 4, wherein the first rubber emulsion is a styrenated butadiene rubber emulsion.

6. The waterproof coating material of claim 4, wherein the second rubber emulsion is a styrene butadiene acrylic copolymer.

7. The waterproof coating material of claim 2, wherein the freeze/thaw additive is propylene glycol.

8. The waterproof coating material of claim 2, wherein the dispersant is potassium tripolyphosphate.

9. The waterproof coating material of claim 1, wherein the fire retardant is aluminum trihydrate.

10. The waterproof coating material of claim 1, wherein the opacity filler is titanium dioxide.

11. The waterproof coating material of claim 2, wherein the diluent is water.

12. The waterproof coating material of claim 1, wherein the thickener is acrylic emulsion thickener.

13. The waterproof coating material of claim 4, wherein the weight percentage of the rubber emulsion in the base coat is in the range of from about 35 wt % to about 45 wt % and the rubber emulsion in the top coat is in the range of from about 60 wt % to about 70 wt %.

14. A method for waterproofing a surface, the method comprising the steps of:
applying a base coat material to a surface to a thickness in the range of from about 25 to about 30 mil, the base coat material having a formula:
about 20 to about 50 percent by weight of a first rubber emulsion;
about 20 to about 40 percent by weight of a second rubber emulsion;
about 10 to about 30 percent by weight of a fire retardant;
about 3 to about 12 percent by weight of an opacity filler; and
about 10 to about 64 percent by weight of other components for affecting characteristics of the base coat material; and
applying a top or finish coat material to the surface over the base coat to a thickness in the range of from about 7 to about 10 mil, the top or finish coat material having a formula:
about 55 to about 75percent by weight of a rubber emulsion;
about 12 to about 30 percent by weight of a fire retardant;
about 3 to about 12 percent by weight of a opacity filler; and
about 0 to about 44 percent by weight of other components for affecting characteristics of the top coat material.

15. The method of claim 14, wherein the base coat and the top or finish coat are applied using an airless sprayer.

16. The method of claim 15, wherein the airless sprayer includes a spray tip in the range of from about 3.17 to about 3.19 mm.

17. A base coat material for waterproofing a surface, the base coat comprising:
about 20 to about 50 percent by weight of a first rubber emulsion;
about 20 to about 40 percent by weight of a second rubber emulsion;
about 10 to about 30 percent by weight of a fire retardant;
about 3 to about 12 percent by weight of an opacity filler; and
about 10 to about 64 percent by weight of other components for affecting characteristics of the base coat material.

18. The base coat material of claim 17, wherein the other components for affecting characteristics of the base coat material are selected from the group consisting of defoamer, freeze/thaw additive, surfactant, biocide, dispersant, fungicide, pigment dispersion, diluent, thickener, and pH adjuster.

19. A top coat material for waterproofing a surface, the top coat comprising:
about 55 to about 75 percent by weight of a rubber emulsion;
about 12 to about 30 percent by weight of a fire retardant;
about 3 to about 12 percent by weight of a opacity filler; and
about 0 to about 44 percent by weight of other components for affecting characteristics of the top coat material.

20. The top coat of claim 19, wherein the other components for affecting characteristics of the top coat material are selected from the group consisting of defoamer, freeze/thaw additive, surfactant, biocide, dispersant, fungicide, diluent, thickener, pH adjuster and the like.
